(19) United States
(12) Patent Application Publication
(10) Pub. No.: US 2009/0068316 A1
(43) Pub. Date: Mar. 12, 2009

(54) PET FOOD MIXTURE, PET FOOD PROCESSING SYSTEM, AND PROCESS FOR MAKING THE PET FOOD

(76) Inventors: JOHN PHELPS, South Orange, NJ (US); Kent Hemphill, Fair Haven, NJ (US); Scott Morris, Chatham, NJ (US); Thomas K. Ray, Claremont, CA (US)

Correspondence Address: DLA PIPER LLP US, P. O. BOX 2758, RESTON, VA, 20195, US

(21) Appl. No.: 12/147,184

(22) Filed: Jun. 26, 2008

Related U.S. Application Data
(60) Provisional application No. 60/946,602, filed on Jun. 27, 2007.

(51) Int. Cl. A23K 1/10; B65B 25/06; A23L 3/01; A23L 3/005; A23K 1/16; A23B 4/01; A23K 1/14; A22C 17/10; A22C 7/00; A21B 7/00

(52) U.S. Cl. 426/73; 426/392; 426/641; 426/647; 426/243; 426/302; 426/240; 426/383; 99/353; 99/348; 426/92; 426/74

(57) ABSTRACT

A pet food mixture, pet food processing system, and process for making the pet food are disclosed. The pet food includes meat pieces formed from a mixture of meat and at least one vegetable, wherein the meat pieces are cooked and coated with a first liquid and color changed to obtain color coated meat pieces, the coated meat pieces providing a balanced nutrition for a pet. The process for making pet food includes forming slugs of a meat mixture, cooking the slugs of meat mixture to form cooked meat pieces, cooling the cooked meat pieces, packaging the meat pieces, and maintaining the meat pieces refrigerated to achive a refrigerated shelf life between approximately 8 weeks and approximately 30 weeks.

### CROSS-REFERENCE TO RELATED APPLICATION

This application is based on and derives the benefit of the filing date of U.S. Provisional Patent Application No. 60/946,602, filed 27 Jun. 2007. The entire contents of this application is herein incorporated by reference in its entirety.

### FIELD OF THE INVENTION

The present invention relates to food in general and more particularly to a pet food mixture, process for making the pet food mixture, and pet food processing system.

### BRIEF DESCRIPTION OF TIE DRAWINGS

FIG. 1 is a schematic diagram of a food processing system for making a pet food, according to an embodiment of the present invention;

FIGS. 2A and 2B show a front view of meat pieces forming device and a side view of the meat pieces forming device, respectively, according to an embodiment of the present invention;

FIG. 2C is a schematic representation of meat pieces forming device in a sequence for forming slugs, according to an alternate embodiment of the present invention;

FIG. 2D is a schematic representation of meat pieces forming device, according to yet another embodiment of the present invention;

FIG. 3A is a schematic internal view of the cooking device, according to an embodiment of the present invention;

FIG. 3B depicts a side view of a cooking device and a broiler device with a conveyor for transporting the meat pieces, according to an embodiment of the present invention;

FIG. 3C depicts a top view of the cooking device, the broiler, the conveyor and a discharge chute with a guiding device, according to an embodiment of the present invention;

FIG. 4 shows a perspective view of a plastic pouch filled with meat pieces (e.g., meatballs), according to an embodiment of the present invention;

FIG. 5 depicts a perspective view of a packaging for receiving one or more pouches shown in FIG. 4, according to an embodiment of the present invention;

FIG. 6 is a diagram showing a positioning of a cooler between the broiler device and the tumble coating device, according to an embodiment of the present invention;

FIG. 7 is a diagram showing a positioning of the cooler after the tumble coating device, according to an embodiment of the present invention;

FIG. 8 is a schematic representation of a cooler in a spiral configuration; and

FIG. 9 depicts a schematic cross-sectional view of a pasteurization vessel used for pasteurizing the meat pieces inside the pouches, according to an embodiment of the present invention.

### DETAILED DESCRIPTION OF EMBODIMENTS OF THE INVENTION

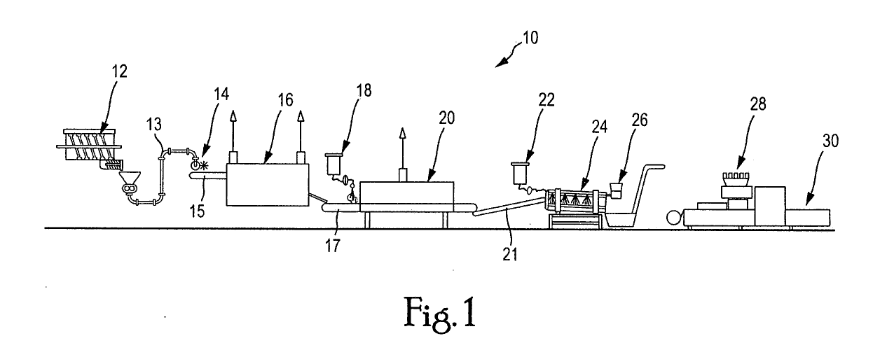

FIG. 1 is a schematic diagram of a food processing system for making a pet food, according to an embodiment of the present invention. The food processing system 10 comprises a food mixing device 12, meat pieces forming device 14, a cooking device 16, a spray coating device 18, a broiling device 20, a liquid spray device 22, a tumble coating device 24, a condiment feeder 26, a measuring device 28 and a packaging device 30.

A meat-based mixture is prepared by mixing meat such as, but not limited to, chicken meat, turkey meat, beef meat, lamb meat, pork meat, or fish and seafood meat, or any combination of two or more of these meats, and optionally any of the following: poultry, pork or beef liver or any combination of two or more thereof, egg compound (e.g., whole egg, egg white, egg yolk, dried egg powder, white egg powder, yolk egg powder, or whole egg powder, or any combination of two or more thereof), flour (e.g., rice flour, corn flour, oat flour, potato flour, soy flour, wheat flour or the like or any combination of two or more thereof), rice starch, tapioca starch, potato starch, corn starch, rice bran, oat bran, beet pulp, chicory root, tomato pomace, fresh, frozen or dry vegetables (e.g., carrots, peas, split peas, green beans, green peppers, red peppers, yellow peppers, or zucchini, etc., or any combination of two or more of these vegetables), salts in all their forms, lactate salt (e.g., calcium lactate salt), sugar or a sugar derivative (e.g., dextrine, glucose, caramel, molasses, or a combination of two or more thereof), garlic or garlic-like substance or any aroma enhancing substance that is natural or synthetic, a humectant (e.g., glycerine from vegetal or animal source, propylene glycol, glyceryl triacetate, fructo-oligosacharides, various polyols like sorbitol, xylitol, maltitol, and polydextrose, honey, salt, sugars, prune, tomato pomace, or chicory root, or any combination of two or more thereof), an acid (e.g., malic acid, maleic acid, malonic acid, citric acid, lactic acid, fumaric acid, ascorbic acid, ascorbate acid, tartaric acid, acetic acid, phosphoric acid, or hydrochloric acid, or any combination of two or more of these acids), a food preservative which can include a natural food preservative and/or a synthetic food preservative (e.g., potassium sorbate, sodium nitrate, sodium nitrite, propylene glycol, sulfur dioxide, monosodium bisulfate, potassium hydrogen sulfite, disodium EDTA, propionates, benzoates, etc., or antioxidants, or a combination of two or more of these compounds), a mineral supplement (e.g., boron, calcium, choline, chlorine, chromium, cobalt, copper, fluorine, iodine, iron, magnesium, manganese, molebdenum, nickel, phosphorus, potassium, selenium, sodium, silicon, sulfur, vanadium, zinc, etc., or any combination of two or more of these minerals), and a vitamin supplement (e.g., vitamin A, B vitamins, vitamin C, vitamin D, vitamin E, or vitamin K, or any combination of two or more of these vitamins) in the food mixing device 12.

In one embodiment, the food mixing device 12 mixes all these ingredients together to form the meat-based mixture while the mixture is cold, for example, at a temperature between about 0° F. and 60° F. However, the meat-based mixture can be mixed at any temperature. An amount of the meat can be in the range of about 30% to about 80% by weight of the total meat-based mixture. An amount of the liver can be between about 0% to about 17% by weight of the total meat-based mixture. An amount of egg compound (e.g., whole egg, egg white, egg yolk, dried egg powder, white egg powder, yolk egg powder, or whole egg powder, or any combination of two or more thereof) can be between about 0% to about 16% by weight of the total meat-based mixture. An amount of the rice bran can be between about 0% to about 10% by weight of the total meat-based mixture. An amount of the flour (e.g., wheat flour, rice flour, oat flour, etc.) can be between about 0% and about 25%. An amount of the rice can be between about 0% to about 10% by weight of the total meat-based mixture. The rice, flour and rice bran can be used to reduce moisture in the meat-based mixture and help in the binding of the meat mixture. An amount of the vegetables can be between about 0% to about 25% by weight of the total meat-based mixture. The vegetable can include carrots (about 0% to about 20% by weight of the total meat-based mixture) and peas (about 0% to about 7% by weight of the total meat-based mixture). An amount of salt can be between about 0% to about 4% by weight of the total meat-based mixture. An amount of lactate salt (e.g., calcium lactate salt) can be between about 0% to about 9% by weight of the total meat-based mixture. An amount of sugar or sugar derivative such as dextrine, maltodextrine, glucose, caramel, or molasses can be between about 0% to about 7% by weight of the total meat-based mixture. An amount of garlic or garlic-like substance or aroma enhancing substance can be between about 0% to about 2% by weight of the total meat-based mixture. An amount of the humectant can between about 0% to about 10% by weight of the total meat-based mixture. The humectant can be used to reduce water activity to below about 0.9. Water activity is a measure of the availability of water in a food for microbial growth such as molds, and is designated aw. Water activity is a measure of the equilibrium humidity above the food in a closed container. A measurement of aw on a food provides information as to which types of microorganisms are most likely to cause spoilage and how close the aw is to the safety limits. An amount of the acid can be between about 0% to about 6% by weight of the total mixture. The acid can be used to lower the overall pH of the meat mixture, e.g., a pH below about 5.8, so as to inhibit or reduce the growth of bacteria in the meat mixture. An amount of the food preservative can be between about 0% to about 1.5% by weight of the total mixture. The food preservative can be used to retard spoilage whether from microbial growth, such as molds, or undesirable chemical changes. An amount of the mineral supplement can be used between about 0% to about 0.9% by weight of the total mixture. An amount of the vitamin supplement can be used between about 0% to about 0.9% by weight of the total mixture. The mineral supplement and/or the vitamin supplement is/are added to increase the mineral and/or vitamin contents of the meat mixture. As shown by the above ranges, all of the ingredients are optional except the meat.

In one embodiment of the invention, chicken meat is used as a meat base for the meat mixture. Chicken meat can include, for example, a mixture of necks, breasts, and backs with or without cartilage and/or bone ground to small grid sizes (i.e., emulsified). Chicken meat can also include a mixture of necks, breasts, and backs that are deboned using a deboner and ground to desired plate sizes (i.e., emulsified). Chicken meat can also include a mixture of deboned or bone-in chicken mixed together in various portions. However, alternatively or in addition to chicken meat, other meats can be used such as pork meat mix, turkey meat mix, beef meat mix, and fish meat mix with various amounts of natural bone left in depending on the formula and/or the nutritional requirements for calcium. The chicken meat or other meat is used in an amount of about 54.72% by weight of the total meat mixture. The liver (e.g. poultry, beef or pork liver) is incorporated in amount of about 12% by weight of the total meat mixture. The egg compound (e.g., whole egg powder) is incorporated in an amount of about 1.8% by weight of the total meat mixture. Rice is incorporated in an amount of about 1.5% by weight of the total meat mixture. Rice bran is incorporated in an amount of about 4.5% by weight of the total meat mixture. Oat flour is incorporated in an amount of about 11% by weight of the total meat mixture. Vegetables are incorporated including carrots in an amount of about 2% by weight of the total meat mixture and dried peas in an amount of about 0.5% by weight of the total meat mixture. Salt is added in an amount of about 1% by weight of the total meat mixture. Calcium lactate salt is added in an amount of about 1.5% by weight of the total meat mixture. Sugar (e.g., dextrine or maltodextrine, etc.) is added in amount of about 2% by weight of the total meat mixture. The humectant (in this example, glycerine) is added in an amount of about 5% by weight of the total meat mixture. The acid is added in an amount of about 1.85% by weight of the total meat mixture. The food preservative (in this example, potassium sorbate) is added in an amount of about 0.5% of the total meat mixture. The vitamin supplement is incorporated in an amount of about 0.065%. The mineral supplement is incorporated in an amount of about 0.065%.

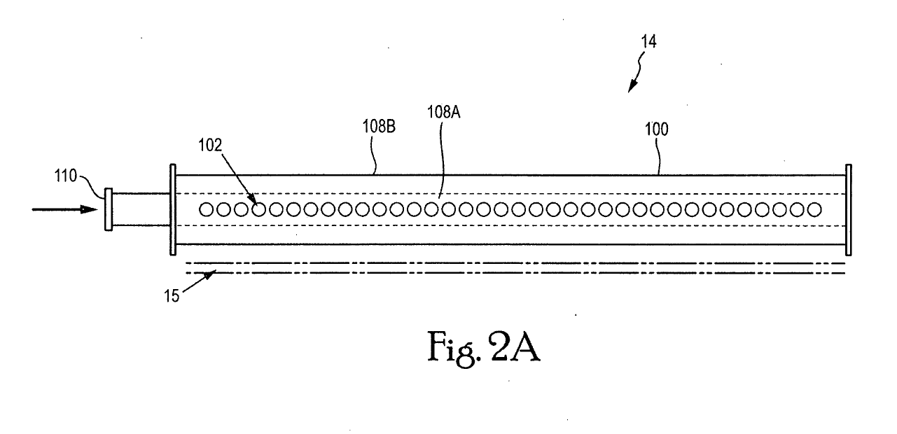

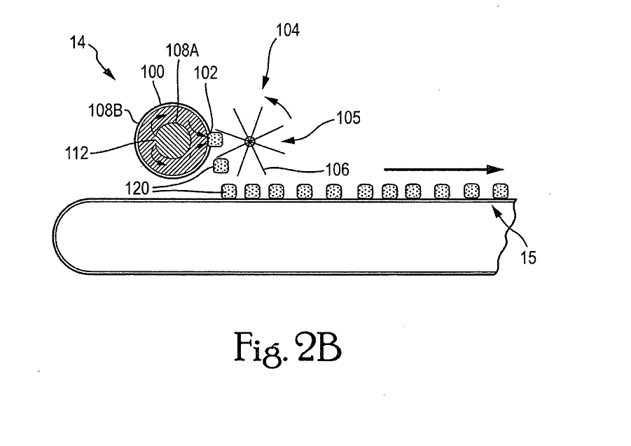

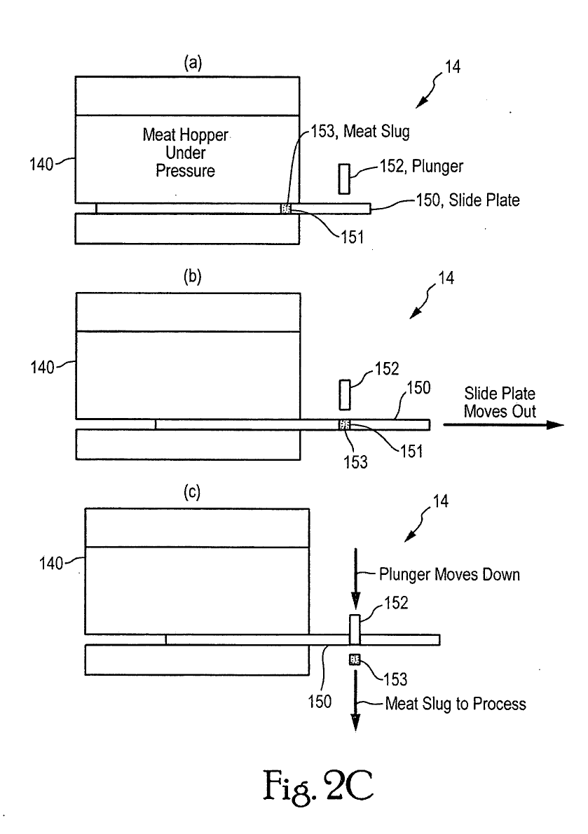

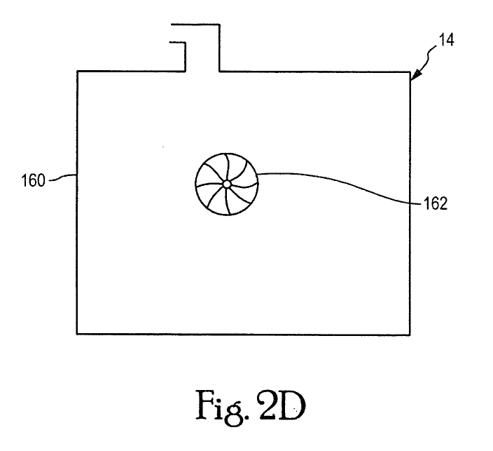

After mixing the meat mixture in the food mixing device 12, the meat mixture is transferred to meat pieces forming device 14 through conduit 13. FIG. 2A shows a front view of the meat pieces forming device 14 and FIG. 2B shows a side view of the meat pieces forming device 14, according to an embodiment of the present invention. As shown in FIGS. 2A and 2B, the meat pieces forming device 14 has a container 100 having a plurality of holes 102 (e.g., about 30, holes) and a circular cutting device 104 having one or more wheels 105 disposed adjacent to a surface of the container 100. The one or more wheels 105 has a plurality of blades 106 and the one or more wheels 105 is disposed adjacent to holes 102. In this embodiment, the container 100 has a cylindrical shape on which holes 102 are disposed in a linear fashion along a surface of the cylindrical container 100. In one embodiment, the container 100 comprises an inner feed tube 108A and an outer extrusion tube 108B on which the holes 102 are provided. The meat mixture is introduced through inlet 110 into the inner feed tube 108A. The inner tube 108A has an opening 112 facing opposite to the holes 102. This allows to equilibrate a pressure inside the container so that a pressure at each hole 102 is approximately the same. The meat mixture is forced through the holes 102 and streams of meat mixture are output through the holes 102 continuously. When the one or more wheels 105 of the cutting device 104 is rotated, each blade 106 cuts through the stream of meat mixture intermittently to form slugs 120 of meat mixture. The slugs 120 then drop onto conveyor 15 which transports the slugs 120 of meat mixture to cooking device 16. In another embodiment, instead of using the blades 106 in the one or more wheels 105 to cut through the stream of the meat mixture, a cutting disk, a cutting plate, or the like can be used to cut through the stream of meat mixture intermittently to form the slugs of meat mixture.

FIG. 2C is a schematic representation of meat pieces forming device 14 in a sequence for forming slugs, according to an alternate embodiment of the present invention. In this embodiment, the meat pieces forming device 14 is a “plug former.” The meat pieces forming device 14 comprises a meat hopper 140, a slide plate 150 and a plunger 152. The slug plate 150 has holes 151. Initially, the slide plate 150 is inside the meat hopper 140. The meat hopper 140 is under pressure so that the meat mixture inside the meat hopper 140 penetrates into the holes 151 of the slug plate 150 so as to fill the holes 151 to form the meat slugs 153, as depicted at the beginning of the sequence at the top of FIG. 2C. The slide plate 150 is then moved, i.e., slid, out of the meat hopper 140 and the plunger 152 is moved down so as to expulse the meat slugs 153 from the holes 151, as shown at the end of the sequence at the bottom of FIG. 2C.

FIG. 2D shows a schematic representation of meat pieces forming device 14 in a sequence for forming slugs, according to yet another embodiment of the present invention. In this embodiment, the meat pieces forming device 14 is an “iris machine.” The meat pieces forming device 14 comprises a meat hopper 160 and an iris or sphincter 162. The meat mixture is under pressure inside the meat hopper 160. The iris or sphincter 162 opens and closes similar to the iris of photographic camera. The meat mixture is forced through the iris 162. By opening and closing the iris 162 meat slugs can be formed. The size and shape of the meat slugs can be varied by varying the speed of opening or closing of the iris 162.

In one embodiment, the slugs of meat mixture are cylindrical in shape. The speed of the stream(s) of meat mixture and the rotation speed of the blades 106 in wheels 105 of the cutting device 104 can be selected so as to change the size of the slugs of meat mixture. The speed of the stream of meat mixture can be changed by changing the pressure of meat mixture inside the container 100 of the forming device 14. In one embodiment, the speed of the stream of meat mixture and the rotation speed of the cutting device is selected so as to form a cylindrically shaped slugs of meat mixture having a base diameter of about 0.75 inch and a height of about 0.75 inch. However, the speed of the stream of meat mixture and the rotation speed of the cutting device can also be selected or adjusted so as to change the height of the slug of meat mixture. In one embodiment, the slug of meat mixture has a base diameter or a height in the range between about 0.25 inch to about 1.5 inches, although any sized slug can be employed. However, the slugs can also be made in other shapes. For example, the slugs can be shaped so as to form, generally round-shaped meat pieces (generally referred to as meatballs), cubic-shaped meat pieces, cylindrical-shaped meat pieces (for example, meat pieces resembling sausages), polygonal-shaped meat pieces, pyramid-shaped meat pieces, heart-shaped meat pieces, flat-wafer-shaped, or other more complex-shaped meat pieces. Furthermore, by running two meat pieces forming devices in parallel where each meat pieces forming device is arranged to form a different shape, color and/or texture of meat pieces, two or more streams of different shapes, colors and/or textures of meat pieces can be mixed together to create a variety of meat pieces that enhances the overall visual appeal. For instance, cubic-shaped meat pieces that are dark brown or golden can be mixed with a small vegetable ball and medium-sized rice ball so that there are three distinct portions blended in a desired proportion to create an appetite appeal as well as a nutritional image.

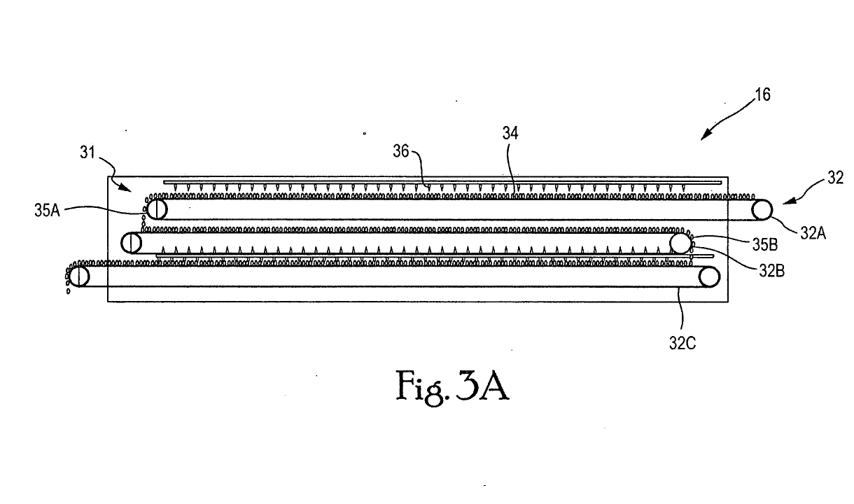

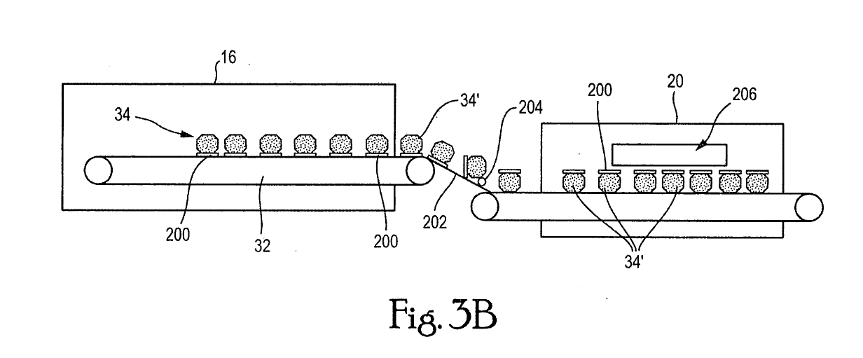

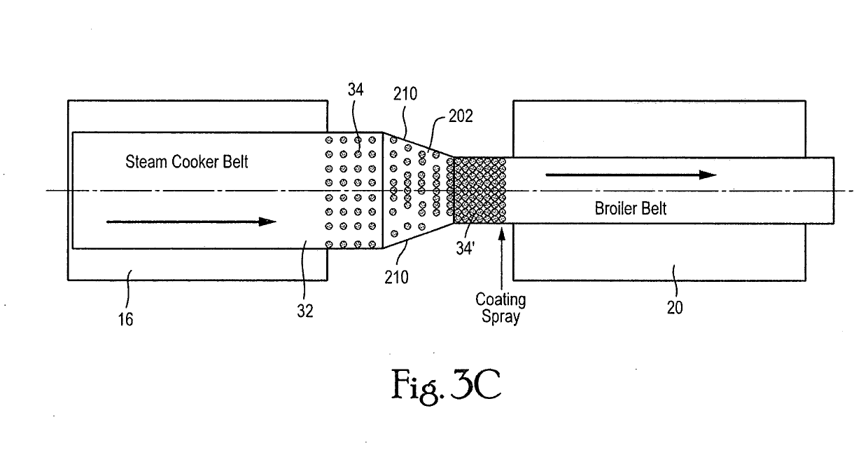

FIG. 3A shows a schematic internal view of the cooking device 16, according to an embodiment of the present invention. In this embodiment, the cooking device 16 is a steam cooker (e.g., a steam blancher) which has a cooking chamber 31. The cooking device 16 also includes one or more conveyors 32 arranged inside the cooking chamber 31. The conveyors 32 may be formed from a wire mesh. The wire mesh in the conveyors 32 allows to create grilled marks on the meat pieces (e.g., meatballs) so as to mimic the effect of grill-marks on a hamburger, as will be described in detail in the following paragraphs. For example, as shown in FIG. 3, three conveyors 32A, 32B and 32C, are arranged inside the cooking chamber. The slugs of meat mixture 34 are transferred to conveyor 32A which guides the slugs of meat mixture into the cooking chamber 31. In one embodiment, conveyor 32A and conveyor 15 can be the same conveyor or can be separate conveyors. Conveyors 32A, 32B and 32C are arranged in a staggered fashion such that when slugs of meat mixture 34 reach an end 35A of conveyor 32A, the slugs 34 drop onto the conveyor 32B and when the slugs 34 reach an end 35B of conveyor 32B the slugs 34 drop onto conveyor 32C. A hot steam of water vapor is introduced by steam headers 36 located on a top portion of the cooking chamber 31. The hot steam of water vapors is directed towards the slugs 34 to cook the slugs of meat mixture when the slugs 34 are on conveyor 32A. Hence, the slugs of meat mixture receive directly the steam of water vapor during a first pass of the slugs of meat mixture inside the cooking chamber while the slugs of meat mixture are on conveyor 32A. During subsequent passes (e.g., the second and third passes), when the slugs are transported by conveyors 32B and 32C, the slugs of meat mixture are “immersed” or maintained in the hot water vapor atmosphere inside the cooking chamber but are not directly subjected to the steam of hot water vapor introduced via the steam headers 36. The slugs of meat mixture are maintained in the hot water vapor atmosphere to allow proper pasteurization and kill bacteria. The slugs of meat mixture are cooked in the cooking device 16 by the steam of hot water vapor generated in the cooking chamber at a temperature between about 180° F. and about 212° F. In one embodiment, the slugs of meat mixture are cooked to a temperature (a core temperature) of approximately 185° F. during a period of about 1 minute to about 3 minutes (e.g., 2.5 minutes) with the direct steam of hot water vapors during the first pass of the slugs of meat mixture in the cooking chamber (when the slugs are on the conveyor 32A) and then the slugs of meat mixture are held at this temperature for about 5 minutes during the second and third passes in the cooking chamber (when the slugs are on conveyors 32B and 32C). However, the cooking time period can be increased or decreased depending on the desired cooking temperature.

In the above embodiment, the cooking device 16 is described as being a steam cooker. However, the cooking device 16 can be any type of cooking device such as, but not limited to, a convection oven, a microwave oven, a microwave-convection oven, or a combination of steam cooker and any one of the convection oven, the microwave oven or the microwave-convection oven.

In an embodiment of the invention, after cooking, the shape of slugs of meat mixture which was initially cylindrical-like is altered by the cooking process. During the cooking process, the proteins, the fat and other ingredients in the slugs of meat mixture start to bind to each other. The shape of the cooked slugs of meat mixture becomes random but generally the cooked slugs of meat mixture can have rounded-like shapes resembling “balls.” Thus, as a result of the cooking process the cooked slugs of meat are referred to as “meatballs.” However, it must be appreciated that the shape of the slugs of meat mixture can be selected such that after the cooking process, the shape of the cooked slugs of meat mixture has a desired shape such as a cubic-shape, a parallelepiped-shape, a cylindrical-shape, an oval-shape (e.g., an egg-like shape), a polygonal-shape (e.g., pyramid-shape), a heart shape, or any other geometric shape, etc. A size of the cooked meat pieces depends on the cooking time inside the cooking device 16. In general, the shape of the meat pieces depends on the initial temperature of the meat mixture, i.e. temperature of the meat mixture in the meat slugs prior to cooking in the cooking device 16. For example, the colder the initial temperature (e.g., about 32° F.) of the meat mixture, the more the meat pieces hold their original shape.

The meat pieces cooked in cooking device 16 are then transferred to broiler device 20 using conveyor 17. In one embodiment, conveyor 17 can be the same conveyor as conveyor 32C provided inside the cooking device 16 or separate conveyors. FIG. 3B depicts a side view of the cooking device 16 and the broiler device 20 with a conveyor for transporting the meat pieces, according to an embodiment of the present invention. As shown in FIG. 3B, after the slugs 34 are cooked inside the cooking device 16 by guiding the slugs using the conveyor system 32, marks 200 from a wire mesh of the conveyors are impressed upon one side of the slugs 34. The slugs 34 exit the cooking device 16 as cooked meat pieces (e.g., meatballs) 34′ with the marks on the lower side of the cooked meatballs 34′. The cooked meat pieces (e.g., meatballs) 34′ slide down a discharge chute 202. A tipping device 204 is disposed in the path of the meat pieces (e.g., meatballs) 34′ along the discharge chute 202, so that when the meat pieces (e.g., meatballs) 34′ hit the tipping device 204, the meat pieces (e.g., meatballs) flip or turn over so that the side with the marks 200 are upright and facing a heating element 206 in the broiler 20. In this way, once the meat pieces (e.g., meatballs) 34′ are broiled, the marks 200 would be exposed to mimic grilled marks similar to grill-marks left on a hamburger. The grill-marking effect can provide an additional visual appeal to the meat pieces (e.g., meatballs) as a whole.

Before entering into the broiler device 20, the meat pieces (e.g., meatballs) are sprayed by a liquid spraying device 18. As stated above, before spraying the meat pieces (e.g., meatballs), at least a portion of the meat pieces (e.g., meatballs) may be turned over so that the grill marks on the bottom are exposed for spraying so as to create meat pieces (e.g., meatballs) with grilled marks for an enhanced visual appeal. The liquid spraying device 18 sprays the meatballs to coat the meat pieces (e.g., meatballs) with the liquid. FIG. 3C depicts a top view of the cooking device 16, the broiler 20, the conveyor 32 and the discharge chute 202 with a guiding device 210 (e.g., guide bars), according to an embodiment of the present invention. To allow for a more efficient spraying of the meat pieces (e.g., meatballs) 34′, guiding device 210 “herd” the meat pieces (e.g., meatballs) 34′ into a more “orderly” configuration prior to spraying, as shown in FIG. 3C. The discharge chute 202 serves at least two purposes. One purpose is to bring the meat pieces (e.g., meatballs) 34′ closer together after being spaced apart inside the cooking device 16 to allow heat penetration from all sides of the meat pieces (e.g., meatballs). The other purpose is to accelerate the meat pieces (e.g., meatballs) 34′ so that the meat pieces (e.g., meatballs) 34′ travel at the speed of the broiler conveyor 17 as the broiler conveyor 17 runs faster than the conveyor 32 in the cooking device 16. In one embodiment the liquid comprises water, vinegar and caramel. Water, vinegar and caramel are mixed together in specific proportions before spraying on the meat pieces (e.g., meatballs). Vinegar is used as an inhibitor of bacterial growth and as a taste enhancer to improve shelf life of the meat pieces (e.g., meatballs). In addition to inhibiting the growth of bacteria, the liquid mixture containing vinegar, caramel and water also improves the overall appearance of the meat pieces (e.g., meatballs) after reaction with heat in the broiler device 20. Indeed, caramel can give the meat pieces (e.g., meatballs) an overall brown/gold effect after reaction with heat via a Maillard reaction. Water is used as a diluting agent to decrease viscosity. In one embodiment, water is used in an amount between about 0% to about 97% by weight of the total liquid mixture. Vinegar is used in an amount between about 0% to about 99.5% by weight of the total liquid mixture. Caramel is used in an amount between about 0.5% to about 7% in weight of the total liquid mixture.

In the broiler device 20, the color of the meat pieces (e.g., meatballs) is changed to improve the overall appearance of the meat pieces. In one embodiment, the meat pieces (e.g., the meatballs) are browned/golden-colored to improve the overall appearance of the meat pieces and also to enhance water retention as the meat pieces are color coated with a crusty brown/golden outer layer. The brown/golden outer layer is a result of the reaction of proteins, fat and the liquid mixture containing vinegar, caramel and water with heat through a Maillard reaction. In addition to improving the overall appearance, the taste of the meat pieces is also enhanced. In a Maillard reaction, the reactive carbonyl group of sugar (e.g., sugar in caramel) interacts with the nucleophilic amino group of the amino acid and an interesting odor and flavor molecules result from the reaction. In the reaction process, hundreds of different flavor compounds can be created. These compounds in turn break down to form yet more new flavor compounds, and so on. Each type of food has a very distinctive set of flavor compounds that are formed during the Maillard reaction. In another embodiment, the meat pieces can be seared. In a further embodiment, the meat pieces can be branded. In yet another embodiment, the meat pieces can be fried. In any of these embodiments, the obtained meat pieces are color coated.

In an embodiment of the invention, the broiler device 20 is an infrared radiation broiler, such as a gas-fired broiler, a wood-fired broiler, a coal-fired broiler, an electrical-powered broiler. The broiler device 20 can also be a convection broiler in which air is blown around the cooking chamber of the broiler device in order to provide a more even broiling. The broiler device 20 can also be a microwave oven or a microwave-convection oven. The meat pieces are exposed to infrared radiation inside the broiler. A temperature inside the broiler can be set to a value between about 300° F. and about 500° F. In this case, the measured core temperature inside the meat pieces (e.g., meatballs) at discharge from the broiler device 20 can be between about 133° F. and about 160° F. The residing time period of the meat pieces inside the broiler device 20 is between about 20 seconds to about 30 seconds. However, the time period can be increased or decreased depending upon the temperature in the broiler or depending on the desired final appearance of the meat pieces when the meat pieces exit the broiler device 20. Alternatively, the broiler device 20 may not be used and can be eliminated. In which case, the color changing of the meat pieces can take place in the atmosphere, for example by reaction with the oxygen in the atmosphere. Alternatively or in addition to using the broiler device 20, a fryer can be used in which case the meat pieces can be fried to obtain fry-coated meat pieces. Alternatively, the meat pieces can also be seared and/or branded with a heat generating device if desired.

After leaving the broiler device 20, the meat pieces (e.g., meatballs) are transferred to tumble coating device 24 using conveyor 21. In one embodiment, in the tumble coating device 24, the meat pieces are sprayed with another liquid and tumbled to homogenously coat the meat pieces with the liquid to enhance shininess, appeal, smell and taste. The liquid also acts as a barrier coat to reduce the growth of bacteria by “sealing” the outer layer of the meat pieces. The liquid comprises a lipid and a flavor and aroma enhancer. The lipid can be any oil such as a vegetable oil (e.g., sunflower oil, safflower oil, corn oil, canola oil, coconut oil, grape seed oil, pumpkin seed oil, rapeseed oil, sesame oil, walnut oil, peanut oil, olive oil, soybean oil, cottonseed oil, or any combination of two or more of these oils), or fat (e.g., beef lard, pork lard, butter, cocoa butter, margarine, etc.), or a combination of two or more thereof. The flavor and aroma enhancer can be chicken broth, beef broth, turkey broth, pork broth, hickory, vanilla, basil, cinnamon, thyme, nutmeg, rosemary, other pet friendly flavor and aroma compounds, or the like, or a combination of two or more of these natural or synthetic compounds. The flavor and aroma enhancer can be dissolved in dry or liquid form into the oil at cold or hot temperature depending on the type of the flavor and aroma enhancer. However, in another embodiment, instead or in addition to coating with a liquid, the meat pieces can also be coated with a powder such as starch or the like.

In the tumble device 24, the liquid coated meat pieces are also spray coated with a condiment by using condiment feeder 26. In one embodiment, the condiment is fed inside the tumble device 24 using air output through a nozzle to help the condiment disperse homogenously inside the tumble device 24. Alternatively, the meat pieces can be also spray coated with one or more condiments using a secondary spray station instead of the tumble device 24. The liquid coating on the meat pieces helps the condiment stick to the meat pieces. Tumbling the meat pieces while the condiment is fed into the tumble device 24 further enhances the homogenous distribution of the condiment on the surface of the meat pieces. The condiment can be, for example, parsley, celery leaves, carrots, mango, salsa, tomato, any dried vegetable or meat or grain, bacon bits, liver bits, grain flakes such as oat flakes, pizza topping, salad, dried spices (e.g., chives, salt, pepper), dried herbs, dried fruit, etc. The condiment is added to improve overall appearance of the meat pieces and/or for its nutritional value. In one embodiment, parsley is used as a condiment as parsley is a good bad-breath reducer. In one embodiment, after coating the meat pieces with the one or more condiments, the meat pieces can be sterilized, for example, by irradiating the meat pieces, for example, using gamma rays or other types of radiation. One source of gamma rays used in food sterilization is cobalt-60.

The condiment-coated meat pieces are then transferred to measuring device 28 so as to weight and divide the meat pieces into portions of approximately equal size. For example the meat pieces are divided into portions weighting about 14 oz which can contain approximately 10 to 100 meat pieces, depending on the size of the meat pieces. The portions of meat pieces -are then transferred into packaging device 30. In one embodiment, the packaging device 30 is Tiromat packaging machine manufactured by Tiromat corporation. In one embodiment, the packaging device is a multivac machine. In another embodiment, the packaging device is a horizontal flexible packaging machine. In one embodiment, a top web of the packaging for containing the meat pieces is made from flexible material and the bottom web is made from a rigid formed material. In which case, the meat pieces would be packaged in semi-rigid ready to serve containers. In the packaging device 30, pouches of flexible plastic are filled with the portions of meat pieces. In one embodiment, air in the pouches is drawn so as to reduce the level of oxygen in the pouches and then the pouches are filled with the meat pieces in an atmosphere filled with nitrogen or an inert gas such as argon, or a combination of these gases. In another embodiment, the pouches are filled with the portions of meat pieces in a modified atmosphere containing nitrogen, inert gas (e.g., argon), carbon dioxide, or carbon monoxide, or any combination of two or more these gases. In one embodiment, the pouches of meat pieces are filled with meat pieces in an atmosphere comprising about 30% to about 70% by weight of nitrogen gas, about 30% to about 70% by weight of carbon dioxide, and about 0% to about 8% by weight of carbon monoxide. The filling of the pouches with meat pieces in an atmosphere comprising nitrogen, inert gas, carbon dioxide, or carbon monoxide, or a combination of two or more of these gases substantially reduces the growth of bacteria in meat pieces thus increasing the overall shelf life of the meat pieces packed in the pouches. Indeed, the presence of nitrogen, inert gas, carbon dioxide or carbon monoxide helps to block reproduction of the bacteria and thus substantially reduce the number of bacteria inside the pouches.

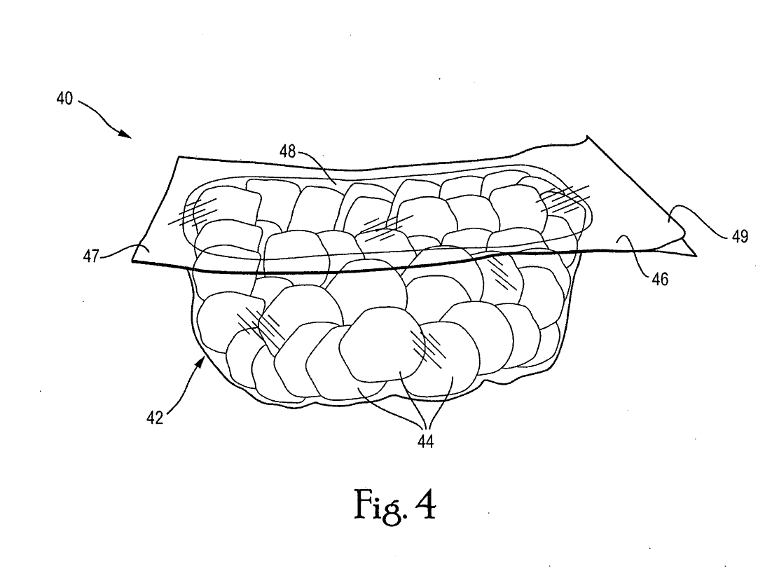

FIG. 4 shows a perspective view of a plastic pouch filled with meat pieces (in this example meatballs), according to an embodiment of the present invention. The pouch 40 has a container 42 for receiving the meatballs 44 and a plastic flap 46 that closes an opening 48 in the container 42. The opening 48 is sealed by the flap 46 so as to substantially eliminate introduction of air into the filled pouch. The flap 46 is sealed around a lip 47 of the container 42. The flap 46 has a tab-like portion to allow a user to pull on the tab 49 and separate the flap 46 from the container 42. The flap 46 can be configured so as be easily peelable from the container 42 by pulling on the tab-like portion 49. Although in FIG. 4, the pouch is shown as having a box-like shape somewhat horizontally elongated the pouch can have any shape such as a vertically elongated box-like shape, a cylindrical shape, a semispherical-shape or any other shape. The pouch 42 can be made of a sheet of flexible plastic such as polyethylene (PE), polypropylene (PP), polyethylene terephthalate (PET) or the like, or a combination of two or more of these plastics. In this embodiment, the sheet of flexible plastic is translucent. However, an additive can be added into the plastic to make the plastic sheet semi-opaque or totally opaque. In addition, a dye or additive can be added to give the plastic sheet a certain color or texture as desired.

After packaging the meat pieces inside the pouches (e.g., pouch 40 filled with meatballs), the meat pieces are still somewhat hot. The temperature of the meat pieces is about 140° F. Thus, the pouches containing the meat pieces are transferred into a cooler for cooling the meat pieces inside the pouches. This process of cooling the meat pieces further inhibits the growth of bacteria in the meat pieces inside the pouches. However, cooling the meat pieces may be optional. In one embodiment, the pouches are run through a spray of water or immersed into a bath of water so as to reduce the temperature of the meat pieces inside the pouches. The temperature inside the pouches is decreased relatively quickly from a temperature in a range of about 100° F. to about 140° F. to a temperature between about 26° F. and about 40° F., for example about 38° F. within a period of approximately 3 hours. Spores of bacteria will bloom at higher temperature (e.g., at around 140° F.). However, by reducing the temperature relatively rapidly, the spores do not bloom and hence the likelihood of multiplication of bacteria inside the pouches during the shelf life of the meat pieces inside the pouches is reduced. Alternatively, in another embodiment, the pouches filled with meat pieces can also be cooled using cold air, cold gas, a cold liquid such liquid nitrogen, or dry ice, etc.

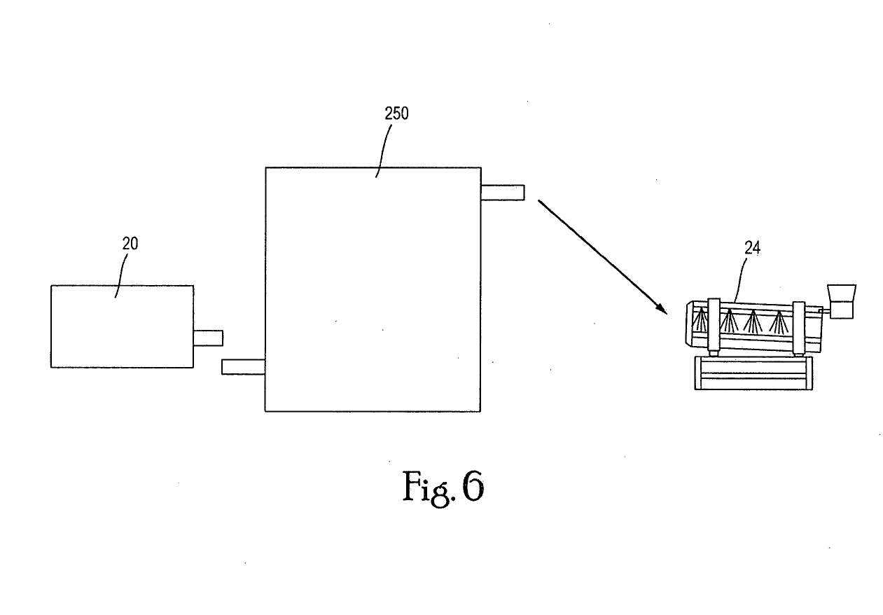

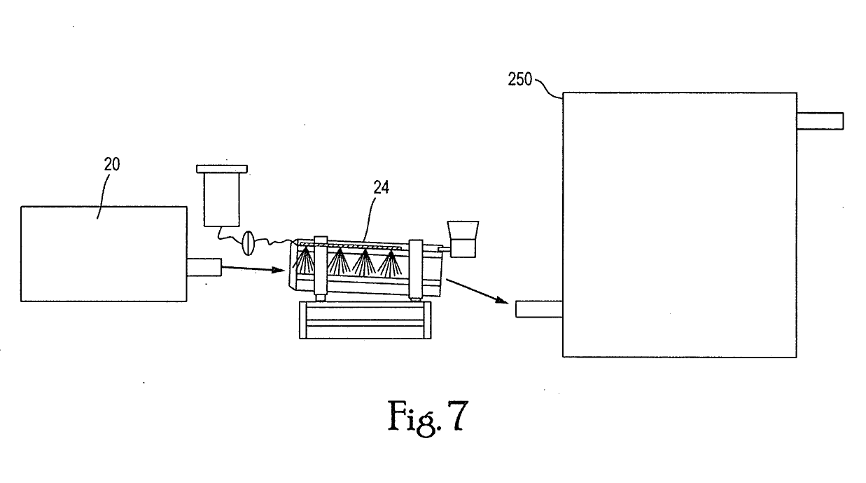

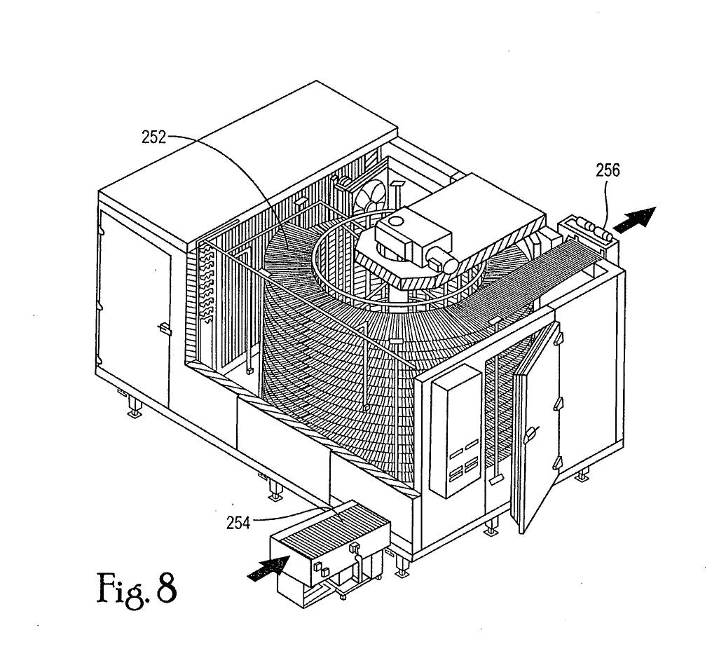

In the above embodiment, the meat pieces are cooled after disposing the meat pieces inside the pouches, alternatively however, the meat pieces can also be cooled before disposing the meat pieces inside the pouches. For example, the meat pieces can be cooled before or after the coating prior to packaging inside the pouches. For example, as shown in FIG. 6, a cooler 250 can be positioned between the broiler device 20 and the tumble coating device 24. In this case, the meat pieces are cooled after exiting the broiler device 20 before transferring the meat pieces to the tumble coating device 24 for coating with a liquid and/or with a condiment. Alternatively, as shown in FIG. 7, the cooler 250 can be positioned after the tumble coating device 24. In this case, the coated meat pieces are cooled before transferring the meat pieces to measuring device 28. In one embodiment, the cooler 250 is a spiral chiller. FIG. 8 is a schematic configuration of a typical spiral chiller. As shown in FIG. 8, the cooler 250 comprises a conveyor 252 arranged in a spiral configuration. In one embodiment, the meat pieces enter the cooler through inlet 254 provided at the bottom of the cooler 250 and exit through outlet 256 provided at the top of the cooler 250. The conveyor 252 guides the meat pieces in a spiral configuration from the bottom of the cooler 250 to the top of the cooler 250. Alternatively, the meat pieces enter the cooler through an inlet provided at the top of the cooler 250 and exit through an outlet provided at the bottom of the cooler 250. In which case, the conveyor 252 guides the meat pieces in a spiral configuration from the top of the cooler 250 to the bottom of the cooler 250. Cold air or any other cold gas is forced through the conveyor (e.g., a wire mesh conveyor) which transports the meat pieces to cool the meat pieces. Air or gas that is warmed by contact with the meat pieces is re-circulated and passed through refrigerated plates to cool the air/gas and then the air/gas is blown again over the meat pieces. This process can be repeated numerous times until the meat pieces are cooled to a desired temperature. The above cooler is described having a conveyor in a spiral configuration. However, the cooler can also have a conveyor of any suitable configuration, a cooler without a conveyor or any other type of cooler.

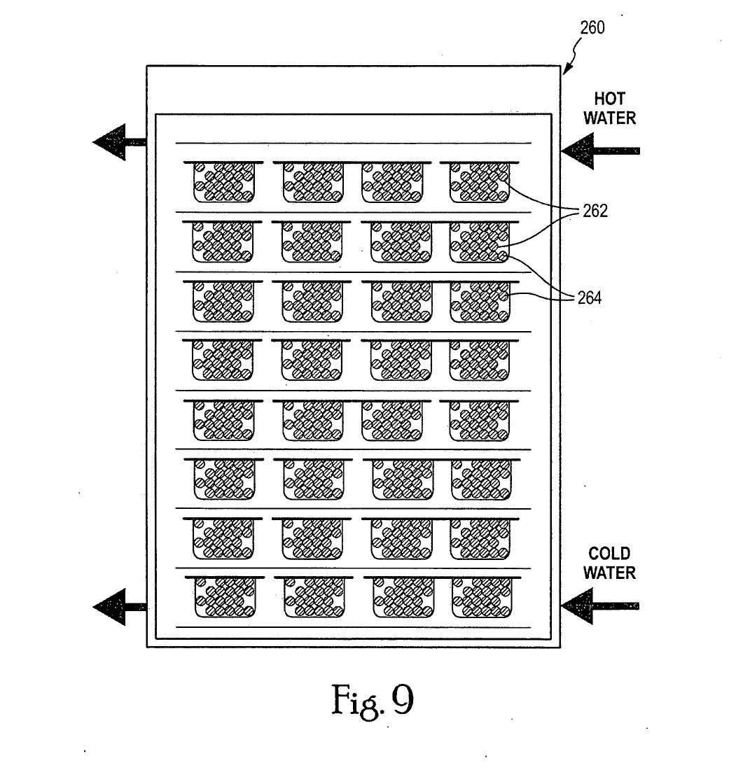

Additionally, the pouches filled with the meat pieces can also be pasteurized to further increase the shelf life of the meat pieces. In the pasteurization process, the meat pieces are heated relatively quickly while the meat pieces are inside the pouches to a temperature adequate to kill most bacteria that may have been in contact with the meat pieces. FIG. 9 depicts a schematic cross-sectional view of a pasteurization vessel used for pasteurizing the meatball inside the pouches, according to an embodiment of the present invention. As shown in FIG. 9, pouches 262 filled with meat pieces 264 are placed in a vessel 260. The vessel 260 is watertight and air tight. Hot water is pumped into the vessel 260 and a temperature of the meat pieces 264 inside the pouches 262 is raised to a temperature between about 170° F. and about 220° F., for example 180° F., in a time period between about 2 minutes to about 60 minutes, for example 40 minutes. The meat pieces 264 are then held at that temperature (e.g., 180° F.) for a period of time between about 1 second to about 2 hours, preferably between about 2 seconds to about 10 seconds, for example 5 seconds. Air pressure is applied to offset the vapor pressure that may occur inside the pouches so as to prevent the pouches from bursting. Cold water at a temperature between about 100° F. and about 32° F. can then be pumped into the vessel 260 to cool the meat pieces 264 inside the pouches 262.

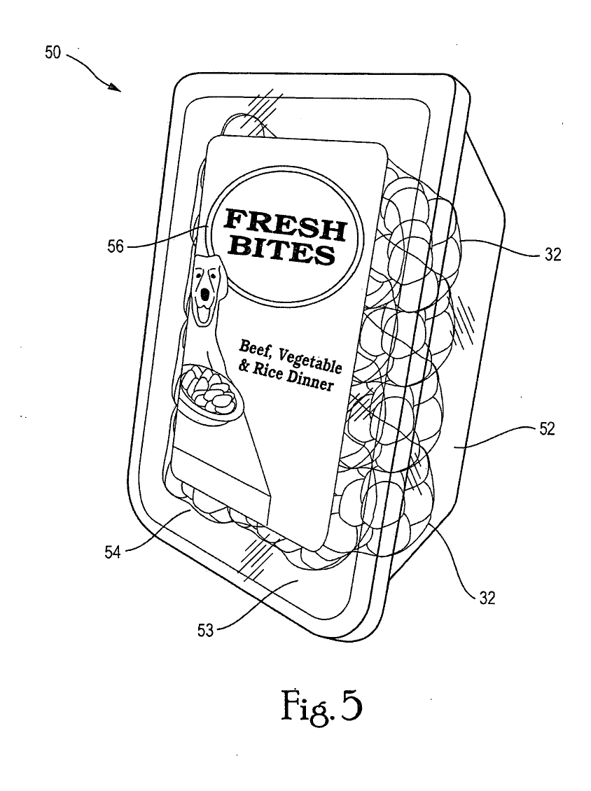

After cooling the pouches filled with the meat pieces, the pouches are packaged in an another plastic pack for delivering to the consumer market. FIG. 5 depicts a perspective view of a packaging 50 for receiving one or more pouches 32, according to an embodiment of the present invention. The packaging 50 has a container 52 provided with an opening 53 and a lid 54. The container 54 can be sized to receive one, two, or more pouches 32. In addition, the pouches can be made in various sizes and/or shapes. For example, as depicted in FIG. 5, the container 54 is sized to receive 2 pouches 32. Although the container 54 is shown having a trapezoid-like shape, the container 54 can be configured to have any shape, including a cylindrical shape, a semi-spherical shape, or other more complex shapes. The lid 54 is configured to close the opening 53 in the container 52. The container 52 and/or the lid 54 can be fabricated from a plastic such as, but not limited to, polypropylene (PP), acrylics (e.g., polymethylmethacrylate (PMMA)), polycarbonate (PC), polyethylene terephthalate (PET), etc., or a combination of two or more of these plastics. In this embodiment, the plastic is transparent or translucent. However, an additive can be added into the plastic to make the plastic semi-opaque or totally opaque. In addition, a dye or additive can be added to give the plastic a certain color or texture as desired. Furthermore, the container 52 and the lid 54 can be fabricated from a same plastic or different plastics or fabricated with different colors and/or textures. In addition, as shown in FIG. 5, artwork 56 can be printed and applied on the lid 54 to provide information about the contents, i.e., the meat pieces, for the consumer. In addition to the artwork, a design logo can also be embossed onto any wall of the container 52 and/or the lid 53 to give the whole packaging an additional branding distinction.

In addition to disposing one or more pouches 32 inside the packaging 50, one or more additive pouches or containers can also be disposed along with the one or more pouches 32 which are filled with meat pieces. For example, the one or more additive pouches or containers may contain a gravy sauce, more vegetables, sprinkles, or other condiments, etc. In addition, the additive container can also include utensils such as a disposable plastic fork, a disposable plastic knife, a disposable plastic spoon, or a disposable plastic spatula, or a combination of two or more thereof. The utensils can be used, for example, to break the meat pieces into smaller bites for smaller, pets such as smaller dogs.

The resulting pet food can be a natural pet food that requires refrigeration. By natural, this application refers to a feed or ingredient derived solely from plant, animal or mined sources, either in its unprocessed state or having been subject to physical processing, heat processing, rendering, purification, extraction, hydrolysis, enzymolysis or fermentation, but not having been produced by or subject to a chemically synthetic process and not containing any additives or processing aids that are chemically synthetic except in amounts as might occur unavoidably in good manufacturing processes as defined in the Association of American Feed Control Officials (AAFCO) guide. That is no chemical preservatives need be added.

The resulting pet food can be a nutritionally complete and balanced. Each meat piece in the pet food contains approximately 100% of the nutrition needed by the pet when the pet is fed according the feeding guidelines which specify the amount of food and the food necessary to achieve a 100% complete and balanced nutrition based on the body weight of the pet. Furthermore, the process described above lightly processes the pet food. By processing the pet food less, the nutrient value from the fresh ingredients in the pet food can be retained and as a result the pet nutrition can be enhanced.

The above process for making pet food can produce a pet food with a shelf life between about 8 weeks and about 30 weeks, when refrigerated, by significantly impeding bacteria growth from spoilage levels without reducing palatability or using preservation techniques that can lead to stool problems for the pets.

To be “fresh” the pet food cannot be shelf stable indefinitely and from a quality point of view a refrigerated shelf life minimum of about 8 weeks may be need to insure a good product quality. Hence the shelf life of the pet food takes into account the palatability of the food and uses a combination of synergistic parameters. To obtain a natural pet food, the synergistic parameters can be selected to be 100% natural. Each one of the parameters works in combination with the remaining parameters to achieve a desired shelf life without negatively impacting the nutrition and/or the palatability of the food for the pet nor negatively impacting the appearance of the food for the pet owner.

For example, one parameter may be the selection of an appropriate salt level between about 0.4% and about 4% by weight of the total mixture. Salt can play a role in the overall palatability of the pet food as well as contribute to the shelf life.

Another parameter is the use of an acid such as lactic acid. The acid can be added to achieve a pH level of the mixture between about 4.5 and about 5.8. In one embodiment, this can be accomplished by adding an amount between about 1.8% and about 6% by weight of the total mixture. The acid can also contribute to shelf life and can be used as a flavor enhancing ingredient.

Another parameter is the use of sugar such as dextrose. The sugar can be added in an amount between about 0.5% and about 7% by weight of the total mixture. Sugar can also contribute to the shelf life and can play a role in the overall palatability of the pet food.

Another parameter is coating the meat pieces with oil such as vegetable oil, as described previously. The meat pieces can be, for example, coated with vegetable oil so as to seal the exterior surface of the meat pieces. Vegetable oil is a hostile environment to airborne bacteria that could land of the food, for example, between the broiler and the sealed package. In addition to allowing the condiments such as carrot fines, parsley, etc. to stick to the exterior surface of the meat pieces, the oil can also give the meat pieces a moist appetizing appearance for the pet owner.

Another parameter is using a humectant, such as a vegetable glycerin. The humectant can be added in an amount between about 1% and about 10% by weight of the total mixture. The humectant can be used to reduce water activity (aw). A measurement of aw on a food provides information as to which types of microorganisms are most likely to cause spoilage and how close the aw is to the safety limits.

Another parameter is controlling the atmosphere inside the pouch which contain the pet food, as described previously. For example in one embodiment, the pouches are filled with the portions of meat pieces in a modified atmosphere containing nitrogen, inert gas, carbon dioxide, or carbon monoxide, or any combination of two or more these gases. The filling of the pouches with meat pieces in an atmosphere comprising nitrogen, inert gas, carbon dioxide, or carbon monoxide, or a combination of two or more of these gases substantially reduces the growth of bacteria in meat pieces thus increasing the overall shelf life of the meat pieces packed in the pouches.

Another parameter is controlling the cooking temperature of the meat pieces. As described previously, a predetermined amount of heat is used to kill well known pathogens such as Salmonella, Listeria, E-Coli, etc. Temperatures lower than a certain minimum temperature threshold in the cooking step could allow pathogenic bacteria to survive, while temperatures that are higher than the maximum temperature may negatively impact the nutrient aspect of the pet food, for example by deteriorating vitamins, fatty acids, and amino acid. Therefore, the temperature in the cooking step is selected to be higher than the minimum threshold temperature and lower than the maximum temperature where the nutrient may be negatively impacted.

Yet another parameter is cooling the meat pieces, as described previously, so that surviving spores cannot germinate. The process of cooling the meat pieces further inhibits the growth of bacteria in the meat pieces inside the pouches. In one embodiment, the meat pieces can be brought to a temperature between about 26° F. and about 40° F. The meat pieces can then be maintained refrigerated so as to achieve a refrigerated shelf life between about 8 weeks and about 30 weeks.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. In fact, after reading the above description, it will be apparent to one skilled in the relevant art(s) how to implement the invention in alternative embodiments. Thus, the present invention should not be limited by any of the above-described exemplary embodiments. Accordingly, all suitable modifications and equivalents should be considered as falling within the spirit and scope of the invention.

In addition, it should be understood that the figures, are presented for example purposes only. The processes, food compositions and packaging of the present invention are sufficiently flexible and configurable, such that it may be utilized in ways other than that shown in the accompanying figures.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope of the present invention in any way.

What is claimed:

1. A process for making a balanced nutritional pet food, comprising:
forming slugs of a meat mixture providing a balanced nutrition for a pet;
cooking the slugs of meat mixture to form cooked neat pieces;
cooling the cooked meat pieces;
packaging the cooked meat pieces; and
maintaining the meat pieces refrigerated to achieve a refrigerated shelf life between approximately 8 weeks and approximately 30 weeks.

2. The process of claim 1, wherein forming the slugs comprises passing the meat mixture through holes of a forming device to obtain a stream of meat mixture and cutting the stream of meat mixture to form the slugs of meat mixture.

3. The process of claim 1, further comprising prior to forming the slugs of meat mixture, mixing meat with a vegetable to form the meat mixture.

4. The process of claim 3, wherein the meat includes chicken meat, turkey meat, beef meat, lamb meat, pork meat, fish meat or seafood meat, or any combination of two or more thereof.

5. The process of claim 3, wherein the meat is used in a proportion between approximately 30% to approximately 80% by weight of the meat mixture.

6. The process of claim 3, wherein the vegetable includes fresh, frozen or dry vegetables.

7. The process of claim 6, wherein the vegetable includes carrots, peas, slit peas, green beans, green peppers, red peppers, yellow peppers, zucchini, or any combination of two or more thereof.

8. The process of claim 1, further comprising prior to forming the slugs of meat mixture, mixing meat with liver, egg compound, rice, rice bran, flour, rice starch, tapioca starch, potato starch, corn startch, oat bran, beet pulp, chicory root, tomato pomace, garlic or garlic-like substance or aroma enhancing substance, salt, lactate salt, sugar, sugar derivative, a humectant, an acid, a mineral supplement, or a vitamin supplement, or any combination of two or more thereof.

9. The process of claim 8, wherein the sugar derivative includes dextrine, maltodextrine, glucose, caramel, or molasses, or a combination of two or more thereof.

10. The process of claim 8, wherein the humectant includes glycerine, propylene glycol, glyceryl triacetate, fructo-oligosacharides, polyol, honey, sugar, prune, tomato pomace, or chicory root, or any combination of two or more thereof.

11. The process of claim 8, wherein the mineral supplement includes boron, calcium, choline, chlorine, chromium, cobalt, copper, fluorine, iodine, iron, magnesium, manganese, molebdenum, nickel, phosphorus, potassium, selenium, sodium, silicon, sulfur, vanadium, or zinc, or any combination of two or more thereof.

12. The process of claim 8, wherein the vitamin supplement includes vitamin A, one or more B vitamins, vitamin C, vitamin D, vitamin E, or vitamin K, or any combination of two or more thereof.

13. The process of claim 1, wherein forming the slugs of meat mixture comprises passing the meat mixture through holes of a meat forming device to form a stream of meat mixture, and intermittently cutting with a blade the stream of meat mixture to form the slugs of meat mixture.

14. The process of claim 13, further comprising selecting a speed of stream of meat mixture, and selecting a speed of cutting of the stream of meat mixture.

15. The process of claim 1, wherein the cooking of the slugs of meat mixture comprises steam cooking the slugs of meat mixture using a steam cooking device.

16. The process of claim 1, wherein the cooking of the slugs of meat mixture comprises microwaving the slugs of meat mixture using a microwave cooking device.

17. The process of claim 16, wherein the cooking of the slugs comprises cooking the slugs at a temperature between approximately 180° F. and approximately 212° F.

18. The process of claim 16, wherein the cooking of the slugs of meat mixture comprises cooking the slugs for a period of approximately 2.5 minutes so that the meat slugs reach a desired temperature and maintaining the slugs of meat mixture at the desired temperature for approximately 5 minutes.

19. The process of claim 18, wherein the cooking of the slugs of meat mixture comprises passing the slugs of meat mixture under a direct steam of water vapors during a first pass in the steam cooking device to reach the desired temperature and maintaining the desired temperature during subsequent passes in the steam cooking device.

20. The process of claim 1, further comprising coating the meat pieces with a first liquid to obtain first liquid coated meat pieces.

21. The process of claim 20, wherein the coating of the cooked meat pieces with the first liquid comprises spraying the cooked meat pieces with a liquid mixture.

22. The process of claim 21, wherein the liquid mixture comprises water, vinegar and caramel.

23. The process of claim 22, wherein water is used in an amount between approximately 0% and approximately 97% by weight of the liquid mixture, vinegar is used in an amount between approximately 0% and approximately 99.5% by weight of the liquid mixture, and caramel is used in an amount between approximately 0.5% and approximately 7% by weight of the liquid mixture.

24. The process of claim 20, further comprising color changing the first liquid coated meat pieces to obtain color coated meat pieces.

25. The process of claim 24, wherein color changing the first liquid coated meat pieces to obtain color coated meat pieces comprises broiling the first liquid coated meat pieces by reaction with heat in a broiler device.

26. The process of claim 25, wherein broiling the first liquid coated meat pieces comprises broiling the meat pieces to obtain meat pieces with a core temperature between approximately 133° F. and approximately 160° F.

27. The process of claim 25, wherein broiling the meat pieces comprises broiling the meat pieces during a time period between approximately 20 seconds and approximately 30 seconds.

28. The process of claim 25, wherein the broiling comprises exposing the meat pieces to infrared radiation.

29. The process of claim 24, wherein color changing the first liquid coated meat pieces comprises browning the first liquid coated meat pieces to obtain brown coated meat pieces.

30. The process of claim 24, wherein color changing the first liquid coated meat pieces comprises searing the first liquid coated meat pieces.

31. The process of claim 24, wherein color changing the first liquid coated meat pieces comprises branding the first liquid coated meat pieces.

32. The process of claim 24, wherein color changing the first liquid coated meat pieces to obtain color coated meat pieces comprises frying the first liquid coated meat pieces.

33. The process of claim 24, further comprising coating the color coated meat pieces with a second liquid to obtain second liquid coated meat pieces.

34. The process of claim 33, wherein the coating of the color coated meat pieces with the second liquid comprises spraying the color coated meat pieces with a liquid comprising a lipid and a flavor enhancer.

35. The process of claim 34, wherein the lipid includes oil or fat, or a combination thereof.

36. The process of claim 35, wherein the oil includes sunflower oil, safflower oil, corn oil, canola oil, coconut oil, grape seed oil, pumpkin seed oil, rapeseed oil, sesame oil, walnut oil, peanut oil, olive oil, or soybean oil, or any combination of two or more thereof.

37. The process of claim 35, wherein the fat includes beef lard, pork lard, butter, cocoa butter, or margarine, or a combination of two or more thereof.

38. The process of claim 34, wherein the flavor enhancer comprises chicken broth, beef broth, hickory, vanilla, basil, cinnamon, thyme, nutmeg, or rosemary, or a combination of two or more thereof.

39. The process of claim 33, further comprising tumbling the second liquid coated meat pieces in a tumble device.

40. The process of claim 33, further comprising coating the second liquid coated meat pieces with a condiment.

41. The process of claim 40, wherein the condiment comprises parsley, celery leaves, carrots, mango, salsa, tomato, a dried vegetable, a dried meat, bacon bits, liver bits, grain flakes, pizza topping, salad, dried spices, dried herbs, or dried fruit, or a combination of two or more thereof.

42. The process of claim 1, wherein cooling the meat pieces comprises decreasing a temperature of the meat pieces from approximately 140° F. to approximately 45° F.

43. The process of claim 1, further comprising impressing marks on the cooked meat pieces, turning the cooked meat pieces, and broiling the meat pieces to expose grill marks on the meat pieces.

44. The process of claim 1,
wherein the forming of the slugs of a meat mixture comprises:
adding a salt to a meat mixture in an amount between approximately 0.4% and approximately 4% by weight of the meat mixture,
adding an acid to the meat mixture in an amount between approximately 1.8% and approximately 6% by weight of the meat mixture such that a pH level of the meat mixture is between approximately 4.5 and approximately 5.8,
adding a sugar to the meat mixture in an amount between approximately 0.5% and approximately 7% by weight of the meat mixture, and
adding a humectant to the meat mixture in an amount between approximately 1% and approximately 10% by weight of the meat mixture,
wherein after cooking the meat pieces, coating the meat pieces with oil,
wherein the packaging of the meat pieces comprises filling pouches with the meat pieces in a modified atmosphere containing nitrogen, inert gas, carbon dioxide, or carbon monoxide, or any combination of two or more these gases, and
wherein the cooling of the meat pieces comprises cooling the meat pieces to a temperature between approximately 26° F. and approximately 40° F.

45. A food processing system, comprising:
a meatball forming device configured to form slugs of meat mixture from a meat mixture;
a cooking device configured to cook the slugs of meat mixture to obtain cooked meat pieces;
a first coating device configured to spray the cooked meat pieces with a first liquid to obtain first liquid coated meat pieces; and
a color changing device configured to change a color of the first liquid coated meat pieces.

46. The food processing system of claim 45, further comprising a meat mixing device configured to mix meat with a vegetable to form the meat mixture

47. The food processing system of claim 45, further comprising a meatball forming device configured to form slugs of meat mixture.

48. The food processing system of claim 47, wherein the meatball forming device comprises a cutting device for cutting a stream of meat mixture to form the slugs of meat mixture.

49. The food processing system of claim 47, wherein the meatball forming device comprises an iris or sphincter configured to open and close to form the slugs of meat mixture.

50. The food processing system of claim 47, wherein the meatball forming device comprises a meat hopper, a slide plate having holes configured to slide in and out of the meat hopper and a plunger configured to expulse slugs of meat mixture formed inside the holes.

51. The food processing system of claim 45, wherein the cooking device comprises a steam cooker, a convection oven, a microwave oven, or a microwave-convection oven, or any combination of two or more thereof.

52. The food processing system of claim 45, wherein a temperature inside the cooking device is set between approximately 180° F. and approximately 212° F.

53. The food processing system of claim 45, wherein the cooking device comprises a cooking chamber and one or more conveyors passing through the cooking chamber of the cooking device.

54. The food processing system of claim 53, wherein the one or more conveyors are arranged such that the slugs of meat mixture are passed under a direct steam of water vapor during a first pass inside the chamber of the cooking device so that the slugs of meat mixture reach a desired temperature and passed subsequent times inside the cooking chamber to maintain the temperature of the slugs.

55. The food processing system of claim 45, wherein the first coating device is a spray coating device configured to spray the cooked meat pieces with a liquid mixture comprising water, vinegar and caramel.

56. The food processing system of claim 45, wherein the color changing device includes a broiler device configured to change a color of the first liquid coated meat pieces to obtain brown or golden coated meat pieces.

57. The food processing system of claim 56, wherein the broiler device is configured to broil the meat pieces at a temperature between approximately 300° F. and approximately 500° F. to obtain meat pieces with a core temperature between approximately 133° F. and approximately 160° F.

58. The food processing system of claim 56, wherein the broiler device comprises an infrared broiler device configured to expose the meat pieces to infrared radiation.

59. The food processing system of claim 45, further comprising a second liquid coater configured to coat the color coated meat pieces with a second liquid to obtain second liquid coated meat pieces.

60. The food processing system of claim 59, wherein the second liquid comprises a lipid and a flavor enhancer.

61. The food processing system of claim 60, wherein the lipid includes oil or fat, or a combination thereof.

62. The food processing system of claim 61, wherein the oil includes sunflower oil, safflower oil, corn oil, canola oil, coconut oil, grape seed oil, pumpkin seed oil, rapeseed oil, sesame oil, walnut oil, peanut oil, olive oil, or soybean oil, or any combination of two or more thereof.

63. The food processing system of claim 61, wherein the fat includes beef lard, pork lard, butter, cocoa butter, or margarine, or any combination of two or more thereof.

64. The food processing system of claim 60, wherein the flavor enhancer comprises chicken broth, beef broth, hickory, vanilla, basil, cinnamon, thyme, nutmeg, or rosemary, or a combination of two or more thereof.

65. The food processing system of claim 59, further comprising a tumble device configured to tumble the second liquid coated meat pieces.

66. The food processing system of claim 59, further comprising a condiment feeder configured to coat the second liquid coated meat pieces with a condiment.

67. The food processing system of claim 66, wherein the condiment comprises parsley, celery leaves, carrots, mango, salsa, tomato, a dried vegetable, a dried meat, bacon bits, liver bits, grain flakes, pizza topping, salad, dried spices, dried herbs, or dried fruit, or a combination of two or more thereof.

68. The food processing system of claim 45, further comprising a packaging device configured to package the meat pieces into plastic pouches.

69. The food processing system of claim 68, wherein the packaging device is configured to form the plastic pouches and fill the plastic pouches with the meat pieces.

70. The food processing system of claim 69, wherein the packaging device is configured to fill the pouches in an atmosphere filled with a gas comprising nitrogen, inert gas, carbon dioxide, or carbon monoxide, or any combination of two or more thereof.

71. The food processing system of claim 68, further comprising a cooler configured to cool the meat pieces inside the plastic pouches.

72. The food processing system of claim 71, wherein the cooler is a spraying water cooler configured to spray water onto the pouches.

73. The food processing system of claim 45, further comprising a cooler configured to cool the meat pieces.

74. The food processing system of claim 73, wherein the cooler is an air cooler or a gas configured to circulate cold air or cold gas around the meat pieces.

75. A pet food, comprising:
meat pieces formed from a mixture of meat and at least one vegetable, wherein the meat pieces are cooked and coated with a first liquid and color changed to obtain color coated meat pieces, the coated meat pieces providing a balanced nutrition for a pet.

76. The pet food of claim 75, wherein the meat includes chicken meat, turkey meat, beef meat, lamb meat, or pork meat or any combination of two or more thereof.

77. The pet food of claim 75, wherein the vegetable includes fresh, frozen or dry vegetables.

78. The pet food of claim 77, wherein the vegetable includes carrots, peas, slit peas, green beans, green peppers, red peppers, yellow peppers, zucchini, or any combination of two or more thereof.

79. The pet food of claim 75, wherein the meat pieces are formed from a mixture of meat with liver, egg compound, rice, rice bran, flour, rice starch, tapioca starch, potato starch, corn starch, oat bran, beet pulp, chicory root, tomato pomace, garlic or garlic-like substance or aroma enhancing substance, salt, lactate salt, sugar, sugar derivative, a humectant, an acid, a food preservative, a mineral supplement, or a vitamin supplement, or any combination of two or more thereof.

80. The pet food of claim 79, wherein the sugar derivative includes dextrine, maltodextrine, glucose, caramel, or molasses, or a combination of two or more thereof.

81. The pet food of claim 79, wherein the humectant includes glycerine, propylene glycol, glyceryl triacetate, fructo-oligosacharides, polyol, honey, sugar, prune, tomato pomace, or chicory root, or any combination of two or more thereof.

82. The pet food of claim 79, wherein the mineral supplement includes boron, calcium, choline, chlorine, chromium, cobalt, copper, fluorine, iodine, iron, magnesium, manganese, molebdenum, nickel, phosphorus, potassium, selenium, sodium, silicon, sulfur, vanadium, or zinc, or any combination of two or more thereof.

83. The pet food of claim 79, wherein the vitamin supplement includes vitamin A, one or more B vitamins, vitamin C, vitamin D, vitamin E, or vitamin K, or any combination of two or more thereof.

84. The pet food of claim 75, wherein the first liquid comprises a mixture of water, vinegar and caramel.

85. The pet food of claim 75, wherein the color coated meat pieces include a second liquid coating to obtain second liquid coated meat pieces.

86. The pet food of claim 85, wherein the second liquid coating comprises a lipid and a flavor enhancer.

87. The pet food of claim 86, wherein the lipid includes oil or fat, or a combination thereof.

88. The pet food of claim 87, wherein the oil includes sunflower oil, safflower oil, corn oil, canola oil, coconut oil, grape seed oil, pumpkin seed oil, rapeseed oil, sesame oil, walnut oil, peanut oil, olive oil, or soybean oil, or any combination of two or more thereof.

89. The pet food of claim 87, wherein the fat includes beef lard, pork lard, butter, cocoa butter, or margarine, or a combination of two or more thereof.

90. The pet food of claim 86, wherein the flavor enhancer comprises chicken broth, beef broth, hickory, vanilla, basil, cinnamon, thyme, nutmeg, or rosemary, or a combination of two or more thereof.

91. The pet food of claim 86, wherein the second liquid coated meat pieces further include a condiment coating.

92. The pet food of claim 91, wherein the condiment comprises parsley, celery leaves, carrots, mango, salsa, tomato, a dried vegetable, a dried meat, bacon bits, liver bits, grain flakes, pizza topping, salad, dried spices, dried herbs, or dried fruit, or a combination of two or more thereof.
